(19) United States
(12) Patent Application Publication
(10) Pub. No.: US 2012/0146944 A1
(43) Pub. Date: Jun. 14, 2012

(54) INPUT APPARATUS AND METHOD FOR DETECTING THE CONTACT POSITION OF INPUT APPARATUS

(75) Inventors: Bang-Won Lee, Yongin-si (KR); Se-Eun Jang, Yongin-si (KR); Jae-Surk Hong, Yongin-si (KR); Xiaoling Wu, Yongin-si (KR)

(73) Assignee: ATLAB INC., Yongin-si (KR)

(21) Appl. No.: 13/391,733

(22) PCT Filed: Aug. 17, 2010
(86) PCT No.: PCT/KR10/05428

§ 371 Date: Feb. 22, 2012

(30) Foreign Application Priority Data
Aug. 25, 2009 (KR) 10-2009-0078878

(51) Int. Cl. G06F 3/044; G06F 3/045

(52) U.S. Cl. 345/174

(57) ABSTRACT

Provided are an input device and a touch position detecting method thereof. The input device includes a touch panel having a plurality of first touch patterns, each of which is disposed in a first direction and outputs a first touch signal at a touch position of the first direction, and a plurality of second touch patterns, each of which is disposed in a second direction perpendicular to the first direction and outputs a second touch signal at a touch position of the second direction, and a touch sensor, where the touch sensor calculates a coordinates of touch position based on the first and second touch signals and storing the coordinates of touch position according to time, wherein the touch sensor performs a first sensing operation of detecting a coordinates of real touch position using the coordinates of touch position previously stored when the number of the touch position is at least two and a time difference between the at least two touch positions is greater than a reference value and performs a second sensing operation of detecting a coordinates of real touch position using an impedance of the touch pattern which vary depending on the touch position when a number of the touch position is at least two and the elapsed time between touching of the at least two touch positions is smaller than or equal to the reference value.

### TECHNICAL FIELD

The present invention relates, in general, to an input device, and more particularly, to an input device having a touch panel and a touch position detecting method thereof.

### BACKGROUND ART

Information processors such as personal computers and portable transmitters carry out various functions using an input device. As this input device, one having a touch panel has recently been used widely.

In general, the touch panel is a device that is installed on a display device, such as a cathode-ray tube (CRT), liquid crystal display (LCD), plasma display panel (PDP), electroluminescent (EL) display or the like, and is capable of detecting a touch position when touched, and may be made using an indium tin oxide (ITO) film.

The input device having this touch panel allows a user to touch a touch object (e.g. a finger or a stylus) to a given position on the touch panel, thereby making it possible to display various pieces of information on a screen. Particularly, in the case of the input device capable of recognizing a multi-touch having a plurality of touch positions, it can carry out zoom-in and zoom-out operations according to a distance between the touch positions, or an operation according to a rotational angle of the touch positions, for instance, rotation of displayed information. When the multi-touch is recognized, it may be difficult to discriminate real touch positions due to ghost patterns.

### DISCLOSURE

### Technical Problem

Accordingly, the present invention has been made in an effort to solve the problems occurring in the related art, and an object of the present invention is to provide an input device capable of discriminating real touch positions even in the presence of ghost patterns.

Another object of the present invention is to provide a touch position detecting method of the input device.

### Technical Solution

In order to achieve the above object, according to an aspect of the present invention, there is provided an input device. The input device includes: a touch panel having a plurality of first touch patterns and a plurality of second touch patterns, each of the first touch patterns being disposed in a first direction and outputting a first touch signal according to a touch position of the first direction, and each of the second touch patterns being disposed in a second direction perpendicular to the first direction and outputting a second touch signal according to a touch position of the second direction; and a touch sensor for calculating a coordinates of touch position based on the first and second touch signals and storing the coordinates of touch position according to time, and the touch sensor performs a first sensing operation of detecting a coordinates of real touch position using the coordinates of touch position previously stored when the number of the touch position is at least two and a elapsed time between touching of the at least two touch positions is greater than a reference value and performs a second sensing operation of detecting a coordinates of real touch position using an impedance of the touch pattern which vary depending on the touch position when the number of the touch position is at least two and the elapsed time is smaller than or equal to the reference value.

Here, each of the first touch patterns may include a plurality of first touch pads disposed in the second direction, and first connection pads connecting the first touch pads in series. Further, each of the second touch patterns may include a plurality of second touch pads disposed in the first direction, and second connection pads connecting the second touch pads in series.

Here, the touch sensor may calculate and store a first coordinates corresponding to the first touch signal and a second coordinates corresponding to the second touch signal when the first touch signal indicates that one of the first touch patterns is touched and the second touch signal indicates that one of the second touch patterns is touched.

Here, the touch sensor may calculate and store a third coordinates corresponding to the first touch signal and a fourth coordinates corresponding to the second touch signal when the first touch signal indicates that at least two of the first touch patterns are touched and the second touch signal indicates that at least two of the second touch patterns are touched after a predetermined time has lapsed following receipt of the first touch signal that indicates one of the first touch patterns is touched and the second touch signal that indicates one of the second touch patterns is touched.

Here, the touch sensor may perform the first sensing operation when one of the third coordinates is the same as the first coordinates, the third coordinates are different from each other, one of the fourth coordinates is the same as the second coordinates, and the fourth coordinates are different from each other.

Also, when the first touch signals indicating that at least two of the first touch patterns are touched and the second touch signals indicating that at least two of the second touch patterns are touched are generated by the touch object touched to the two or more touch positions of the touch panel, the touch sensor may perform the second sensing operation by using the impedance of at least one of the touched first and second touch patterns, or applying a pulse signal to one of the touched second touch patterns and then determining through which of the touched first touch patterns the pulse signal is output.

Meanwhile, the touch sensor may set a discrimination region required to discriminate the real touch positions on the touch panel, and perform the first sensing operation or the second sensing operation to detect the coordinates of the real touch positions when the touch positions have a plurality of coordinates within the discrimination region. Otherwise, the touch sensor may perform the first sensing operation or the second sensing operation to detect the coordinates of the real touch positions only when an application program executed in the input device needs to calculate the coordinates of the real touch positions.

In addition, the touch sensor may perform the second sensing operation to detect the coordinates of the real touch positions when a rotational axis of the coordinates of the touch positions is identical to the first or second direction.

According to an aspect of the present invention, there is provided a touch position detecting method of an input device, in which the input device includes: a touch panel having a plurality of first touch patterns, each of which is disposed in a first direction and outputs a first touch signal according to a touch position of the first direction, and a plurality of second touch patterns, each of which is disposed in a second direction perpendicular to the first direction and outputs a second touch signal according to a touch position of the second direction; and a touch sensor receiving the first and second touch signals to calculate coordinates of the touch positions and storing the coordinates of the touch positions according to time. The touch position detecting method comprises: when the number of touch position is at least two, determining whether or not a elapsed time between touching of the at least two touch position is greater than a reference value; as a result of the determination, when the elapsed time is greater than the reference value, performing a first sensing operation of detecting coordinates of real touch positions using the coordinates of touch position previously stored; and as a result of the determination, when the elapsed time is smaller than the reference value, performing a second sensing operation of detecting coordinates of real touch positions using an impedance of the touch pattern which vary depending on the touch position.

Here, the determining whether or not the elapsed time is greater than the reference value may include calculating and storing a first coordinates corresponding to the first touch signal that indicates one of the first touch patterns is touched and a second coordinates corresponding to the second touch signal that indicates one of the second touch patterns is touched; determining whether or not elapsed time between receipt of the first touch signal that indicates at least two of the first touch patterns are touched and the second touch signal that indicates at least two of the second touch patterns are touched and receipt of the first touch signal that indicates one of the first touch patterns is touched and the second touch signal that indicates one of the second touch patterns is touched is greater than the reference value; and calculating and storing a third coordinates corresponding to the first touch signal that indicates at least two of the first touch patterns are touched and a fourth coordinates corresponding to the second touch signal that indicates at least two of the second touch patterns are touched.

Here, when one of the third coordinates is the same as the first coordinates, the third coordinates are different from each other, one of the fourth coordinates is the same as the second coordinates, and the fourth coordinates are different from each other, the first sensing operation may be performed.

Also, when the first touch signals indicating that at least two of the first touch patterns are touched and the second touch signals indicating that at least two of the second touch patterns are touched are generated by the touch object touched to the at least two touch positions of the touch panel, the second sensing operation is performed by using impedances of the touch patterns which vary depending on the touch position with respect to at least one of the touched first and second touch patterns.

Otherwise, when the first touch signals indicating that at least two of the first touch patterns are touched and the second touch signals indicating that at least two of the second touch patterns are touched are generated, performing the second sensing operation may include applying a pulse signal to one of the touched second touch patterns; and determining through which of the touched first touch patterns the pulse signal is output.

Meanwhile, the touch position detecting method may further include setting a discrimination region required to discriminate the real touch positions on the touch panel, and the determination, the first sensing operation, and the second sensing operation may be performed when the touch positions have a plurality of coordinates within the discrimination region.

Further, the touch position detecting method may further include determining whether or not an application program executed in the input device needs to calculate the coordinates of the real touch positions. As a result of the determination, when the application program needs to calculate the coordinates of the real touch positions, the determination, the first sensing operation, and the second sensing operation may be performed.

In addition, the touch position detecting method may further include determining whether or not a rotational axis of the coordinates of the touch positions is identical to the first or second direction. As a result of the determination, when the rotational axis is identical to the first or second direction, the second sensing operation may be performed.

### Advantageous Effects

Thus, the input device and the touch position detecting method thereof according to exemplary embodiments of the present invention can more rapidly detect the coordinates of the real touch positions when recognizing a multi-touch even in the presence of the ghost patterns.

### DESCRIPTION OF DRAWINGS

FIG. 1 illustrates the configuration of an input device according to an exemplary embodiment of the present invention.

FIGS. 2 and 3 illustrate real touch positions and ghost patterns when a plurality of touch positions are detected.

FIG. 4 illustrates the configuration of an example of measuring a value of resistance to discriminate ghost patterns from real touch positions in the input device according to an exemplary embodiment of the present invention.

FIG. 5 illustrates the configuration of an example of measuring a value of capacitance to discriminate ghost patterns from real touch positions in the input device according to an exemplary embodiment of the present invention.

FIG. 6 is a flowchart for explaining a touch position detecting method of the input device according to an exemplary embodiment of the present invention.

FIG. 7 is a view for explaining an example of setting a discrimination region.

FIG. 8 is a view for explaining an example of additionally needing to discriminate ghost patterns from real touch positions.

### MODE FOR INVENTION

Hereinafter, an input device and a touch position detecting method thereof according to exemplary embodiments of the present invention will be described with reference to the accompanying drawings.

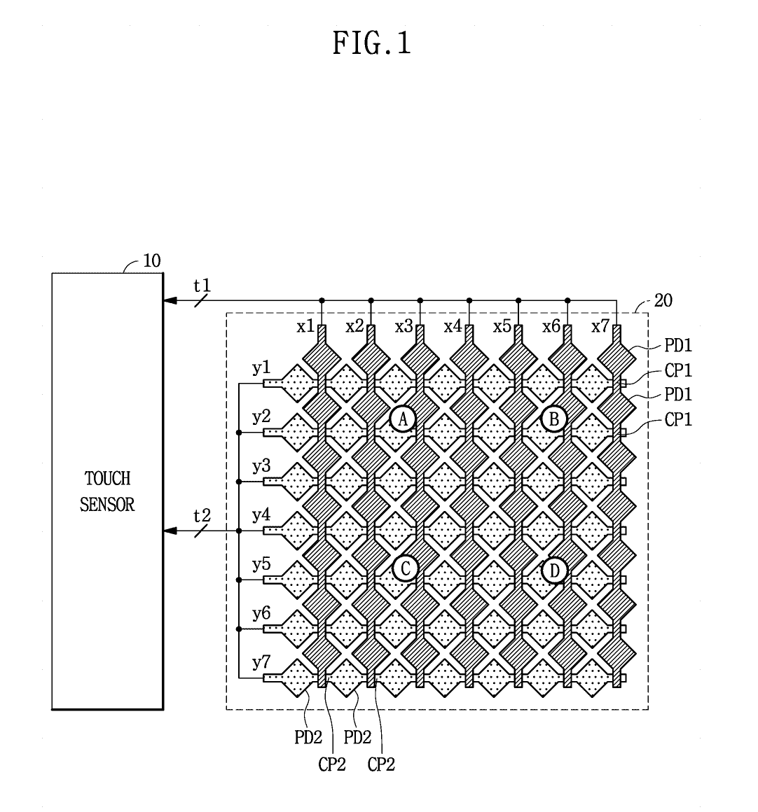

FIG. 1 illustrates the configuration of an input device according to an exemplary embodiment of the present invention. The input device of the present invention may include a touch sensor 10 and a touch panel 20. The touch panel 20 may include a plurality of first touch patterns x1 to x7 and a plurality of second touch patterns y1 to y7.

A function of each block illustrated in FIG. 1 will be described below.

The touch sensor 10 receives first and second touch signals t1 and t2 generated through the touch panel 20, and then calculates a coordinates of a touch position to which a touch object is touched on the touch panel 20. Further, in the case in which the touch positions are plural in number, the touch sensor 10 discriminates a real touch position from a ghost pattern. A method of discriminating the real touch position from the ghost pattern will be described below.

Although not illustrated, the touch sensor 10 may output a reference signal (e.g. a reference clock signal having a pulse form) to a terminal opposite a terminal from which the first touch signal t1 of each of the first touch patterns x1 to x7 of the touch panel 20 is generated, or a terminal opposite a terminal from which the second touch signal t2 of each of the second touch patterns y1 to y7 of the touch panel 20 is generated, and receive the first touch signal t1 or the second touch signal t2 to calculate the coordinates of the touch position, or discriminate the real touch position from the ghost pattern.

The first touch patterns x1 to x7 of the touch panel 20 may be disposed in a first direction, and the second touch patterns y1 to y7 of the touch panel 20 may be disposed in a second direction. Intersections between the first touch patterns x1 to x7 hatched with inclined lines and the second touch patterns y1 to y7 hatched with points are formed so as to be insulated from each other. For example, the first touch patterns x1 to x7 may be formed on the front surface of an indium tin oxide (ITO) film, whereas the second touch patterns y1 to y7 may be formed on the rear surface of the ITO film. The first touch patterns x1 to x7 and the second touch patterns y1 to y7 may be formed on one of the front and rear surfaces of the ITO film, and the intersections between the first touch patterns x1 to x7 and the second touch patterns y1 to y7 may be electrically disconnected from one another. Both the first touch patterns x1 to x7 and the second touch patterns y1 to y7 may be formed on different ITO films, respectively. Thus, the first touch patterns x1 to x7 and the second touch patterns y1 to y7 may be formed in various ways.

In the first touch patterns x1 to x7, the first touch signal t1 is generated corresponding to the touch position of the first direction (e.g. the x-axial direction). In detail, each of the first touch patterns x1 to x7 is configured such that the touch signal is generated depending on whether or not the touch object is touched, and thus the touch signals generated through the first touch patterns x1 to x7 are the first touch signals t1. Accordingly, the touch sensor 10 may receive the first touch signals t1 generated through the first touch patterns x1 to x7, and detect the touch position of the first direction.

The touch signal generated through each of the first touch patterns x1 to x7 is a pulse signal whose delay value varies depending on whether or not the touch object is touched, or a bit signal having one bit whose binary value varies or a plurality of bits whose binary values vary depending on whether or not the touch object is touched. For example, as mentioned above, the touch sensor 10 may be configured to apply a reference signal to the terminal of each of the first touch patterns x1 to x7, and input the touch signals generated through the first touch patterns x1 to x7 as the first touch signals t1. In this case, each touch signal may be a signal that is output after the reference signal is delayed by a predetermined time, and the delayed time may be determined based on whether or not each of the first touch patterns x1 to x7 is touched.

In the second touch patterns y1 to y7, the second touch signal t2 is generated corresponding to the touch position of the second direction (e.g. the y-axial direction). In detail, like the first touch patterns x1 to x7, each of the second touch patterns y1 to y7 is configured such that the touch signal is generated depending on whether or not the touch object is touched. Thus, the touch signals generated through the second touch patterns y1 to y7 are the second touch signals t2. Accordingly, the touch sensor 10 may receive the second touch signals t2 generated through the second touch patterns y1 to y7, and detect the touch position of the second direction.

Further, as illustrated in FIG. 1, each of the first touch patterns x1 to x7 may include a plurality of first touch pads PD1 disposed in the second direction (i.e. y-axial direction) and a plurality of first connection pads CP1 connecting the respective first touch pads PD1. Similarly, each of the second touch patterns y1 to y7 may include a plurality of second touch pads PD2 disposed in the first direction (i.e. x-axial direction) and a plurality of second connection pads CP2 connecting the respective second touch pads PD2.

Also, it is illustrated in FIG. 1 that the first and second touch pads PD1 and PD2 each have the shape of a rhombus. However, the first and second touch pads PD1 and PD2 may each have the shape of a circle or another polygon. In other words, the first and second touch pads PD1 and PD2 may be pads regularly disposed in a specific region having a predetermined shape.

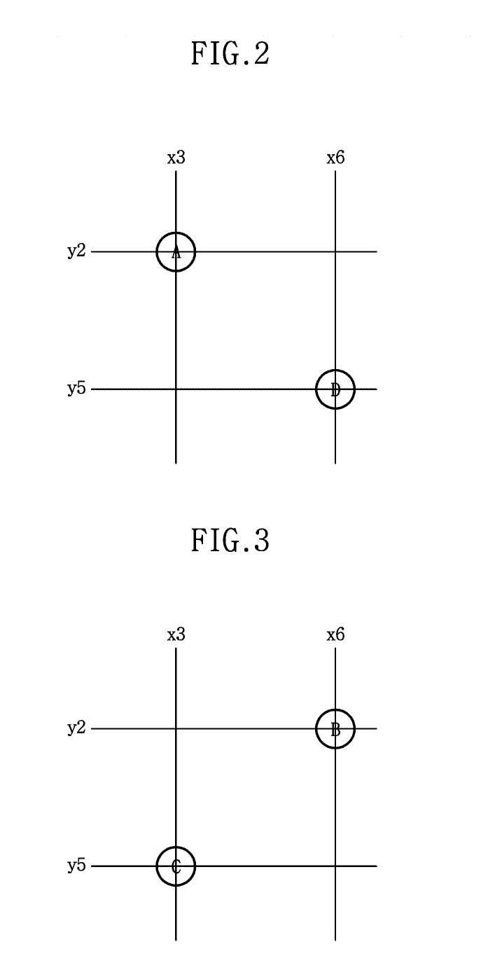

FIGS. 2 and 3 illustrate real touch positions and ghost patterns when a plurality of touch positions are detected.

A method of detecting the touch positions through the touch sensor 10 of the present invention and a method of detecting the coordinates of the real touch positions when the number of touch positions is plural will be described with reference to FIGS. 2 and 3.

When a touch object is touched to a position A of FIG. 1, only a touch signal generated through the third x3 of the first touch patterns x1 to x7 indicates a touched state, and only a touch signal generated through the second y2 of the second touch patterns y1 to y7 indicates a touched state. In other words, the first touch signal t1 indicates that the touch object is touched to the third x3 of the first touch patterns x1 to x7, and the second touch signal t2 indicates that touch object is touched to the second y2 of the second touch patterns y1 to y7.

Similarly, when a touch object is touched to a position B of FIG. 1, the first touch signal t1 indicates that the touch object is touched to the sixth x6 of the first touch patterns x1 to x7, and the second touch signal t2 indicates that touch object is touched to the second y2 of the second touch patterns y1 to y7. Further, when a touch object is touched to a position C of FIG. 1, the first touch signal t1 indicates that the touch object is touched to the third x3 of the first touch patterns x1 to x7, and the second touch signal t2 indicates that touch object is touched to the fifth y5 of the second touch patterns y1 to y7. In addition, when a touch object is touched to a position D of FIG. 1, the first touch signal t1 indicates that the touch object is touched to the sixth x6 of the first touch patterns x1 to x7, and the second touch signal t2 indicates that touch object is touched to the fifth y5 of the second touch patterns y1 to y7.

Thus, the touch sensor 10 may receive the first and second touch signals t1 and t2 to detect the touch position.

Meanwhile, as illustrated in FIGS. 2 and 3, if the touch positions are plural in number, this may give rise to a problem.

As illustrated in FIG. 2, when the touch object is touched to the positions A and D at the same time, the first touch signals t1 indicate that the touch object is touched to the third and sixth x3 and x6 of the first touch patterns x1 to x7, and the second touch signals t2 indicate that the touch object is touched to the second and fifth y2 and y5 of the second touch patterns y1 to y7. On the other hand, as illustrated in FIG. 3, even when the touch object is touched to the positions B and C at the same time, the first touch signals t1 indicate that the touch object is touched to the third and sixth x3 and x6 of the first touch patterns x1 to x7, and the second touch signals t2 indicate that the touch object is touched to the second and fifth y2 and y5 of the second touch patterns y1 to y7.

In detail, when the first touch signals t1 indicate that the touch object is touched to at least two (e.g. the third and sixth x3 and x6) of the first touch patterns x1 to x7, and when the second touch signals t2 indicate that the touch object is touched to at least two (e.g. the second and fifth y2 and y5) of the second touch patterns y1 to y7, it is difficult to determine real touch positions to which the touch object is actually touched due to ghost patterns. When the real touch positions are the positions A and D illustrated in FIG. 2, the positions B and C illustrated in FIG. 3 are the ghost patterns. In contrast, when the real touch positions are the positions B and C illustrated in FIG. 3, the positions A and D illustrated in FIG. 2 are the ghost patterns.

In the method of determining the real touch positions when the number of touch positions is plural, an example is configured to store the touch positions sequentially detected according to time, and detect the coordinates of the real touch positions using the previously detected touch position.

For example, when the touch object is touched to one A of the touch positions of the touch panel 20, both the first touch signal t1 indicating that the touch object is touched to the third x3 of the first touch patterns x1 to x7 and the second touch signal t2 indicating that the touch object is touched to the second y2 of the second touch patterns y1 to y7 are generated. The touch sensor 10 may determine that the touch object is touched to the touch position A by receiving the first and second touch signals t1 and t2. Here, the touch sensor 10 calculates and stores a first coordinates (e.g. an x-axial coordinates of the first touch pattern x3) corresponding to the first touch signal t1 and a second coordinates (e.g. a y-axial coordinates of the second touch pattern y2) corresponding to the second touch signal t2.

Afterwards, after a predetermined time has lapsed, when at least two (e.g. A and D) of the touch positions of the touch panel 20 are touched, the first touch signals t1 indicating that the touch object is touched to the third and sixth x3 and x6 of the first touch patterns x1 to x7 are generated, and the second touch signals t2 indicating that the touch object is touched to the second and fifth y2 and y5 of the second touch patterns y1 to y7 are generated.

The touch sensor 10 receives the first and second touch signals t1 and t2, and determines whether or not the ghost patterns associated with the previously stored first and second coordinates exist. When the ghost patterns exist, the touch sensor 10 detects the real touch positions using the previously stored first and second coordinates. More specifically, the touch sensor 10 generates third coordinates (e.g. coordinates corresponding to the x-axial positions of the first touch patterns x3 and x6) corresponding to the first touch signals t1, and fourth coordinates (e.g. coordinates corresponding to the y-axial positions of the second touch patterns y2 and y5) corresponding to the second touch signals t2. If such conditions as following are met: one (e.g. the coordinates corresponding to the x-axial position of the first touch pattern x3) of the third coordinates (e.g. the coordinates corresponding to the x-axial positions of the first touch patterns x3 and x6) is as same as the first coordinates (e.g. the x-axial coordinates of the first touch pattern x3): the third coordinates (e.g. the coordinates corresponding to the x-axial positions of the first touch patterns x3 and x6) are different from each other: one (e.g. the coordinates corresponding to the y-axial position of the second touch pattern y2) of the fourth coordinates (e.g. the coordinates corresponding to the y-axial positions of the second touch patterns y2 and y5) is as same as the second coordinates (e.g. the y-axial coordinates of the second touch pattern y2): the fourth coordinates (e.g. coordinates corresponding to the y-axial positions of the second touch patterns y2 and y5) are different from each other, the touch sensor 10 may determine that the ghost patterns associated with the previously stored first and second coordinates exist.

In this case, the touch sensor 10 detects the real touch position using the first coordinates (e.g. the x-axial coordinates of the first touch pattern x3) and the second coordinates (e.g. the y-axial coordinates of the second touch pattern y2), both of which are previously stored. In detail, the touch sensor 10 recognizes that the touch object is previously touched to the position A using the first coordinates (e.g. the x-axial coordinates of the first touch pattern x3) and the second coordinates (e.g. the y-axial coordinates of the second touch pattern y2), both of which are previously stored, the touch sensor 10 may determine that the touch object is touched to the positions A and D as illustrated in FIG. 2. In other words, the touch sensor 10 may detect that the positions to which the touch object is actually touched are the positions A and D.

If both the first touch signal t1 indicating that the touch object is touched to the first touch pattern x3 and the second touch signal t2 indicating that the touch object is touched to the second touch pattern y5 are generated and input into the touch sensor 10, the touch sensor 10 may determine that the touch object is touched to the position C using the above-mentioned method. Afterwards, after a predetermined time has lapsed, when the first touch signals t1 indicating that the touch object is touched to the first touch patterns x3 and x6 and the second touch signals t2 indicating that the touch object is touched to the second touch patterns y2 and y5 are input, the touch sensor 10 may determine whether or not the ghost patterns associated with the previously stored first and second coordinates exist through a method similar to the above-mentioned method. The touch sensor 10 may determine that the touch object is touched to the positions B and C using the information that the touch object is previously touched to the position C, as illustrated in FIG. 3. In other words, the touch sensor 10 may detect that the positions to which the touch object is actually touched are the positions B and C.

In the case in which the touch object is touched to two or more touch positions between which a time difference exists (that is, a elapsed time between touching of two or more touch positions is greater than a predetermined reference value), the ghost patterns may be discriminated from the real touch positions using the method of the above-mentioned example. However, in the case where there is no time difference between the two or more touch positions, it is impossible to discriminate the ghost patterns from the real touch positions using the method of the above-mentioned example.

In the method of determining the real touch positions when the number of touch positions is plural, another example is configured to measure impedances of the touched touch patterns which vary depending on the touch position, and detect coordinates of the real touch positions. According to the other example as described below, the real touch positions may be discriminated from the ghost patterns even when no time difference can be distinguished between two or more touch positions.

For example, when both the first touch signals t1 indicating that the touch object is touched to the first touch patterns x3 and x6 and the second touch signals t2 indicating that the touch object is touched to the second touch patterns y2 and y5 are input, the touch sensor 10 may detect the real touch positions using a value of resistance between the touch position and a measuring terminal through which the touch signal is output with respect to at least one of the touch patterns x3, x6, y2 and y5 to which the touch object is touched. In detail, if the touch position corresponding to a resistance value measured between the measuring terminal of the second touch pattern y2 and the touch position is the position A, the touch sensor 10 may detect that the coordinates of the real touch positions are the positions A and D as illustrated in FIG. 2. If the touch position corresponding to the measured resistance value is the position B, the touch sensor 10 may detect that the coordinates of the real touch positions are the positions B and C as illustrated in FIG. 3.

As another example, when the touch object is touched to the touch positions A and D, the impedance between the touch patterns y2 and x3 has a relatively small value. On the basis of this principle, the touch sensor 10 may apply a pulse signal to one (e.g. y2) of the touched second touch patterns, and then determine through which of the touched first touch patterns (e.g. x3 and x6) the pulse signal is output. When the pulse signal is applied to the second touch pattern (y2) and is output through the first touch pattern (x3), the touch sensor 10 may detect that the coordinates of the real touch positions are the coordinates of the positions A and D. Thereby, the coordinates of the real touch positions may be detected.

As yet another example, when the first touch signals t1 indicating that the touch object is touched to the first touch patterns x3 and x6 and the second touch signals t2 indicating that the touch object is touched to the second touch patterns y2 and y5 are input, the touch sensor 10 may detect the real touch positions using a value of capacitance with respect to at least one of the touch patterns x3, x6, y2 and y5 to which the touch object is touched.

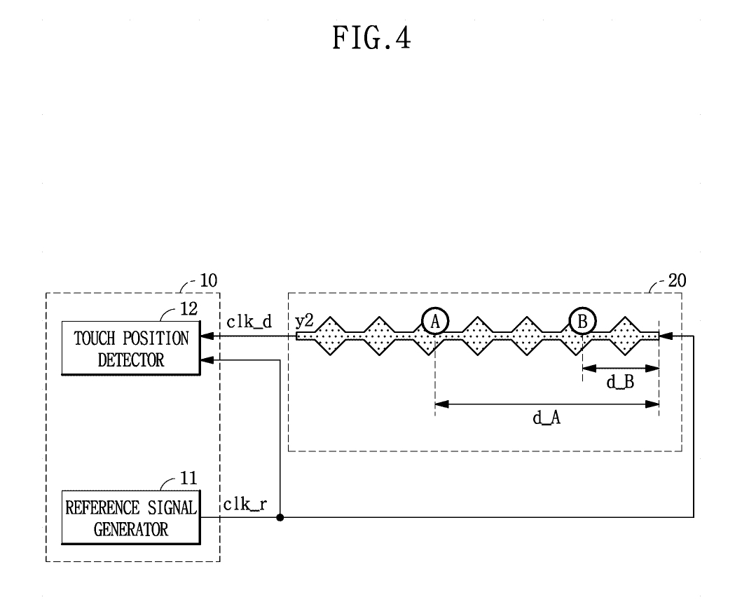

FIG. 4 illustrates a configuration of an example of an input device for detecting real touch positions using a value of resistance between a measuring terminal through which a touch signal is output and a touch position with respect to at least one of touch patterns to which a touch object is touched, and particularly an example of measuring the resistance value of the second touch pattern y2 of the touch patterns x3, x6, y2 and y5 to which the touch object is touched. In this case, the touch sensor 10 of the input device may include a reference signal generator 11 and a touch position detector 12.

A function of each block shown in FIG. 4 will be described below.

The reference signal generator 11 outputs a reference clock signal “clk_r” to a first terminal opposite a second terminal through which the touch signal of the second touch pattern y2 is output, and then to the touch position detector 12.

The touch position detector 12 receives a delay clock signal “clk_d” as a touch signal, and detects a delay time difference between the delay clock signal “clk_d” and the reference clock signal “clk_r”, thereby determining whether the touch object is touched to the touch position A or B.

In detail, in the second touch pattern y2, a delay time of the delay clock signal “clk_d” is determined by a resistance value between the first terminal to which the reference clock signal “clk_r” is applied and the position A or B to which the touch object is touched. The resistance value between the first terminal to which the reference clock signal “clk_r” is applied and the position A or B to which the touch object is touched is proportional to a distance d_A or d_B between the first terminal to which the reference clock signal “clk_r” is applied and the position A or B to which the touch object is touched. Thus, the delay time of the delay clock signal “clk_d” is proportional to the distance d_A or d_B between the first terminal to which the reference clock signal “clk_r” is applied and the position A or B to which the touch object is touched. Accordingly, when the delay time difference between the delay clock signal “clk_d” and the reference clock signal “clk_r” is detected, the position to which the touch object is touched may be detected, so that the ghost patterns can be discriminated from the real touch positions. To be specific, when it is determined that the touch patterns x3, x6, y2 and y5 are touched, and when the position to which the touch object is touched is detected as the position A by the detected delay time difference, the real touch positions are the positions A and D. Further, when it is determined that the touch patterns x3, x6, y2 and y5 are touched, and when the position to which the touch object is touched is detected as the position B by the detected delay time difference, the real touch positions are the positions B and C.

The touch sensor 10 illustrated in FIG. 4 may be used to determine whether or not the touch pattern is touched. For example, the touch sensor 10 measures the delay time difference from each of the touch patterns x1 to x7 and y1 to y7, thereby determining whether or not each of the touch patterns x1 to x7 and y1 to y7 is touched, and simultaneously stores each delay time difference. Afterwards, when the ghost patterns exist and thus need to be discriminated from the real touch positions, the touch sensor 10 may detect the real touch positions on the basis of the stored delay time differences using the above-mentioned method.

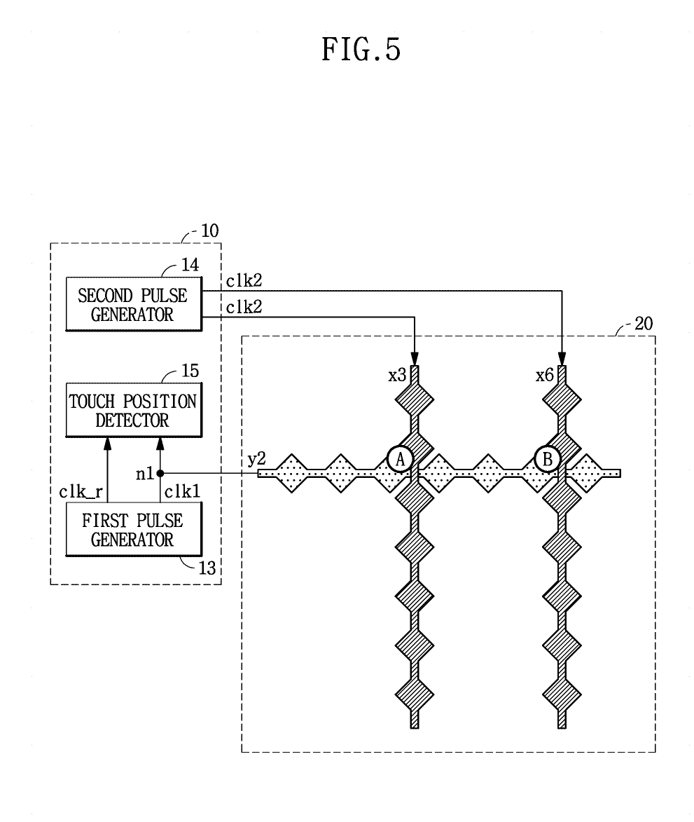

FIG. 5 illustrates a configuration of another example of an input device for detecting a real touch position using a value of capacitance with respect to at least one of touch patterns to which a touch object is touched, and particularly another example of measuring the capacitance value of the second touch pattern y2 of the touch patterns x3, x6, y2 and y5 to which the touch object is touched. In this case, the touch sensor 10 of the input device may include a first pulse generator 13, a second pulse generator 14, and a touch position detector 15.

A function of each block shown in FIG. 5 will be described below.

The first pulse generator 13 outputs a first clock signal clk1 to a node n1 joined with a second terminal through which the touch signal of the second touch pattern y2 is output, and a reference clock signal “clk_r” to the touch position detector 15. The first clock signal clk1 may be a pulse type signal having a positive voltage.

The second pulse generator 14 outputs a second clock signal clk2 to the first touch patterns x3 and x6 in turn. The second clock signal clk2 may be a pulse type signal having a negative voltage.

The touch position detector 15 detects a delay time difference between the reference clock signal “clk_r” and the first clock signal clk1 input through the node n1, and thus detects the real touch positions.

In detail, first, the second pulse generator 14 applies the second clock signal clk2 to one x3 of the first touch patterns x3 and x6, and the touch position detector 15 detects the delay time difference. Here, the delay time difference is referred to as a first delay time difference. Next, the second pulse generator 14 applies the second clock signal clk2 to the other x6 of the first touch patterns x3 and x6, and the touch position detector 15 detects the delay time difference. Here, the delay time difference is referred to as a second delay time difference. The first delay time difference differs from the second delay time difference depending on whether the position to which the touch object is touched is the position A or B. Thus, the position to which the touch object is touched may be detected using the first and second delay time differences. For example, if the first delay time difference is less than the second delay time difference, it may be determined that the position to which the touch object is touched is the position A. If not, it may be determined that the position to which the touch object is touched is the position B. Thus, when it is determined that the touch patterns x3, x6, y2 and y5 are touched, and when the position to which the touch object is touched is the position A, the real touch positions are the positions A and D. Further, when it is determined that the touch patterns x3, x6, y2 and y5 are touched, and when the position to which the touch object is touched is the position B, the real touch positions are the positions B and C.

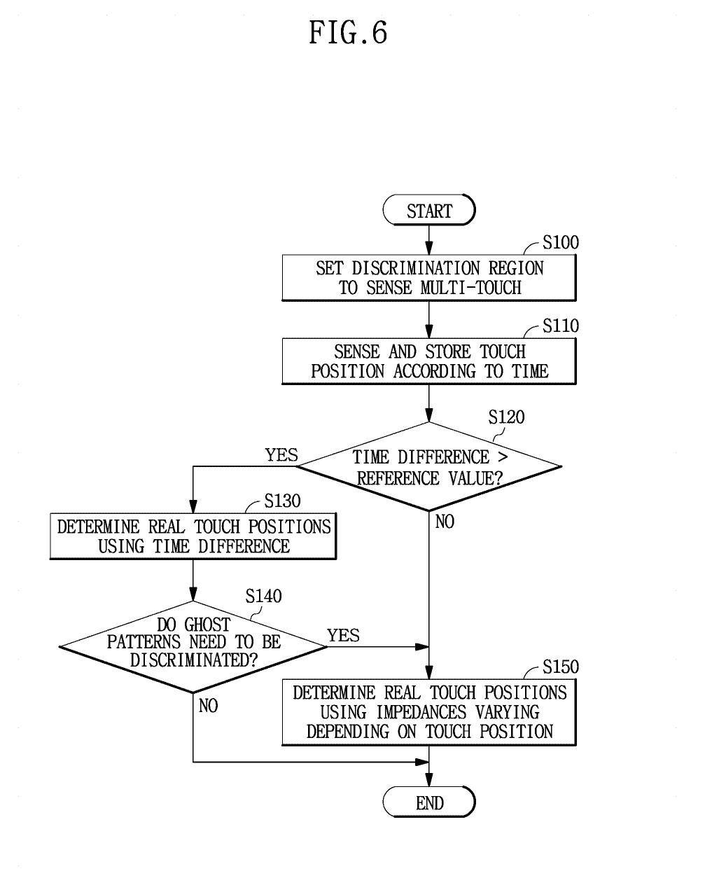

FIG. 6 is a flowchart for explaining a method of detecting a touch position of an input device according to exemplary embodiments of the present invention.

The method of detecting the touch position of the input device according to exemplary embodiments of the present invention will be described below with reference to FIG. 6.

First, the touch sensor 10 sets a discrimination region where a multi-touch needs to be sensed within the entire regions of the touch panel 20, i.e. where a ghost pattern needs to be discriminated from a real touch position (S100).

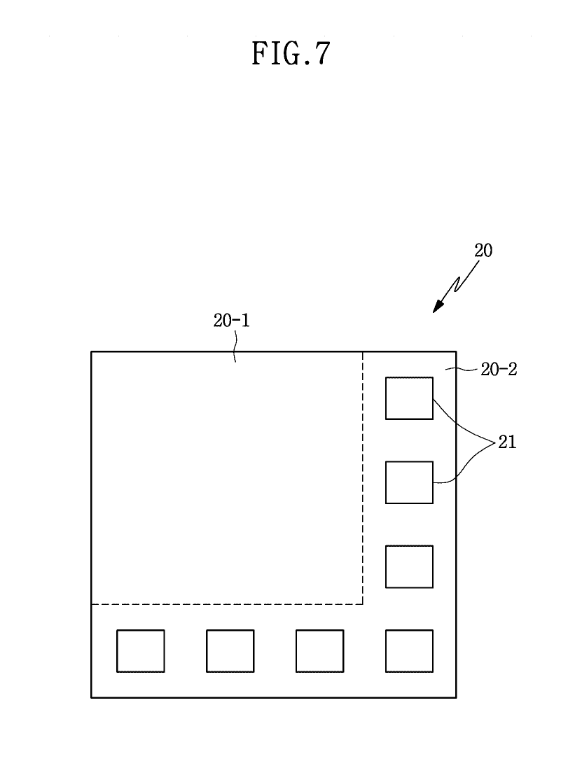

Referring to FIG. 7 by way of an example, the touch panel 20 may be divided into a first region 20-1 and a second region 20-2. The first region 20-1 is a region where the touch position is sensed for movement, enlargement, or rotation of an image displayed on a screen according to a change in touch position, whereas the second region 20-2 is a region where one of icons 21 displayed on the screen is selected such that a function corresponding to the selected icon 21 is performed. Thus, the second region 20-2 may not be required to sense the multi-touch, and the first region 20-1 may be required to discriminate the real touch position from the ghost pattern. The input device of the present invention may be configured to set the first region 20-1 as the discrimination region, and to discriminate the real touch position from the ghost pattern only when a plurality of touch positions are sensed within the discrimination region. As another example, in the case of a table computer, a region where a single worker can work may be set as the discrimination region.

Next, the touch sensor 10 calculates and stores first and second coordinates corresponding to first and second signals t1 and t2 according to time (S110).

Subsequently, when the touch object is touched to a plurality of touch positions, the touch sensor 10 determines whether or not a elapsed time between touching of the touch to positions to which the touch object is touched is greater than a predetermined reference value. In other words, the touch sensor 10 determines whether or not the touch object is touched to one of the touch positions of the touch panel 20 and then at least two of the touch positions of the touch panel 20 after a predetermined time has lapsed (S120).

In operation S120, when the number of touch positions is plural, the touch sensor 10 determines whether or not to detect the elapsed time between touching of the touch positions. The reference value may be a relative value. For example, when the input device and the system including the input device are operated in a normal state, the reference value may be very small. When the input device and the system including the input device are operated in a standby state, the reference value may have a relatively great value. The reasons are as follows: In the standby state, a speed at which a touch is sensed is often set to be low in order to reduce power consumption. Further, when a button is manipulated for a wake-up operation in the state where the touch object is touched to two or more of the touch positions, it is impossible to detect the elapsed time between touching of two or more of the touch positions.

As a result of determination in operation S120, if the elapsed time is greater than the predetermined reference value, i.e. if the touch object is touched to one of the touch positions of the touch panel 20 and then two or more of the touch positions of the touch panel 20 after the predetermined time has lapsed, the coordinates of the real touch positions are detected using one of the touch positions (S130). A detailed description of the detection has been made, and thus will be omitted.

Next, it is determined whether or not the ghost patterns additionally need to be discriminated from the real touch positions (S 140). For example, in the application in which an image is rotated, when a rotational angle amounts to 0° (i.e. when the direction of a rotating axis is identical to an x-axial direction) or 90° (i.e. when the direction of a rotating axis is identical to a y-axial direction), it may be determined whether or not the ghost pattern needs to be discriminated from the real touch position.

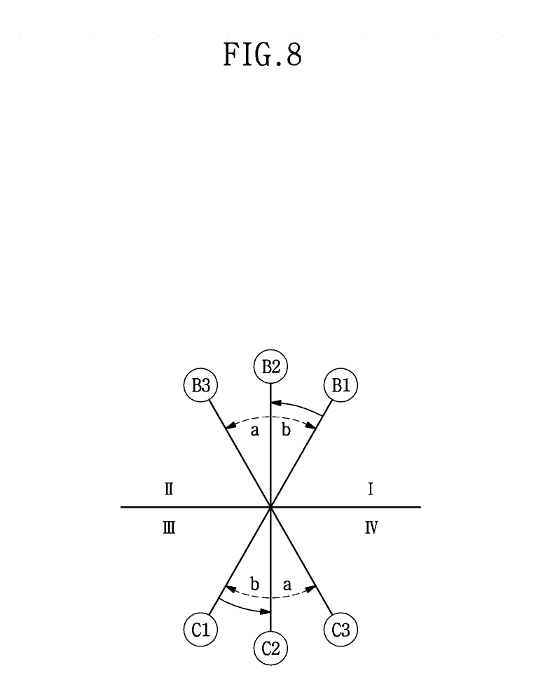

Referring to FIG. 8, first, when positions B1 and Cl are determined as the real touch positions, the real touch positions may be determined to be within quadrants I and III before the rotational angle of the touch positions (i.e. the angle between a line connecting the positions B1 and C1 and the x axis) amounts to 90°. After the rotational angle amounts to 90°, it is difficult to determine whether the real touch positions are located in quadrants II and IV or quadrants I and III. In other words, if the rotational angle continues to vary after amounting to 90°, it is difficult to determine whether the real touch positions are rotated in a direction a or b. This applies equally to the case where the rotational angle amounts to 0°. When the rotational angle amounts to 90° or 0°, it may be determined whether or not the ghost patterns additionally need to be discriminated from the real touch positions.

As a result of determination in operation S120, if the elapsed time is less than the predetermined reference value, i.e. if the elapsed time between touching of two or more of the touch positions of the touch panel 20 cannot be distinguished, for instance if the touch object is touched to one of the touch positions of the touch panel 20 and then two or more of the touch positions of the touch panel 20 before the predetermined time has lapsed, or if the touch object is simultaneously touched to two or more of the touch positions, or as a result of determination in operation S140, if it is determined whether or not the ghost patterns additionally need to be discriminated from the real touch positions, the coordinates of the real touch positions are detected using impedances of the touched touch patterns which vary depending on the touch position (S150).

In the method of detecting the touch position of the input device according to the present invention, it is not necessary to carry out all the operations of FIG. 6, and thus only some of the operations may be carried out as needed. For example, among the operations S110 and S130 of storing the touch positions sequentially detected according to time and then detecting the coordinates of the real touch positions using the previously detected touch position, and the operation S150 of detecting the real touch positions using the impedance varying depending on the touch position, only one or both may be used.

Further, although not illustrated, some or all of the operations of FIG. 6 may be carried out according to an application program. For example, when a zoom-in or zoom-out operation is performed according to distance between the touch positions, it is not necessary to discriminate the ghost patterns from the real touch positions, and thus it is unnecessary for the operations of FIG. 6 to be carried out. However, when an operation, for instance rotation of displayed information according to the rotational angle of the touch positions, is carried out, it is necessary to discriminate the ghost patterns from the real touch positions. Thus, when the application program rotates the displayed information, some or all of the operations of FIG. 6 may be carried out.

In the drawings and specification, typical exemplary embodiments of the invention have been disclosed, and although specific terms are employed, they are used in a generic and descriptive sense only and are not for the purposes of limitation, the scope of the invention being set forth in the following claims.

1. An input device comprising:
a touch panel having a plurality of first touch patterns and a plurality of second touch patterns, each of the first touch patterns being disposed in a first direction and outputting a first touch signal according to a touch position of the first direction, and each of the second touch patterns being disposed in a second direction perpendicular to the first direction and outputting a second touch signal according to a touch position of the second direction; and
a touch sensor for calculating a coordinates of touch position based on the first and second touch signals and storing the coordinates of touch position according to time,
wherein the touch sensor performs a first sensing operation of detecting a coordinates of real touch position using the coordinates of touch position previously stored when the number of the touch position is at least two and a elapsed time between touching of the at least two touch position is greater than a reference value, and performs a second sensing operation of detecting a coordinates of real touch position using an impedance of the touch pattern which vary depending on the touch position when the number of the touch position is at least two and the elapsed time is smaller than or equal to the reference value.

2. The input device as set forth in claim 1, wherein each of the first touch patterns includes:
a plurality of first touch pads disposed in the second direction; and
first connection pads connecting the first touch pads.

3. The input device as set forth in claim 2, wherein each of the second touch patterns includes:
a plurality of second touch pads disposed in the first direction; and
second connection pads connecting the second touch pads.

4. The input device as set forth in claim 1, wherein the touch sensor calculates and stores a first coordinates corresponding to the first touch signal and a second coordinates corresponding to the second touch signal when the first touch signal indicates that one of the first touch patterns is touched and the second touch signal indicates that one of the second touch patterns is touched.

5. The input device as set forth in claim 4, wherein the touch sensor calculates and stores a third coordinates corresponding to the first touch signal and a fourth coordinates corresponding to the second touch signal when the first touch signal indicates that at least two of the first touch patterns are touched and the second touch signal indicates that at least two of the second touch patterns are touched after a predetermined time has lapsed following receipt of the first touch signal that indicates one of the first touch patterns is touched and the second touch signal that indicates one of the second touch patterns is touched.

6. The input device as set forth in claim 5, wherein the touch sensor performs the first sensing operation when one of the third coordinates is the same as the first coordinates, the third coordinates are different from each other, one of the fourth coordinates is the same as the second coordinates, and the fourth coordinates are different from each other.

7. The input device as set forth in claim 1, wherein, when the first touch signals indicating that at least two of the first touch patterns are touched and the second touch signals indicating that at least two of the second touch patterns are touched are generated, the touch sensor performs the second sensing operation using the impedance of at least one of the touched first and second touch patterns.

8. The input device as set forth in claim 1, wherein, when the first touch signals indicating that at least two of the first touch patterns are touched and the second touch signals indicating that at least two of the second touch patterns are touched are generated, the touch sensor performs the second sensing operation by applying a pulse signal to one of the touched second touch patterns and then determining through which of the touched first touch patterns the pulse signal is output.

9. The input device as set forth in claim 1, wherein the touch sensor sets a discrimination region required to discriminate the real touch positions on the touch panel, and performs the first sensing operation or the second sensing operation to detect the coordinates of the real touch positions when the touch positions have a plurality of coordinates within the discrimination region.

10. The input device as set forth in claim 1, wherein the touch sensor performs the first sensing operation or the second sensing operation to detect the coordinates of the real touch positions only when an application program executed in the input device needs to calculate the coordinates of the real touch positions.

11. The input device as set forth in claim 1, wherein the touch sensor performs the second sensing operation to detect the coordinates of the real touch positions when a rotational axis of the coordinates of the touch positions is identical to the first or second direction.

12. A touch position detecting method of an input device, in which the input device includes: a touch panel having a plurality of first touch patterns, each of which is disposed in a first direction and outputs a first touch signal according to a touch position of the first direction, and a plurality of second touch patterns, each of which is disposed in a second direction perpendicular to the first direction and outputs a second touch signal according to a touch position of the second direction; and a touch sensor receiving the first and second touch signals to calculate a coordinates of the touch positions and storing the coordinates of the touch positions according to time, the touch position detecting method comprising:
when the number of touch position is at least two, determining whether or not a elapsed time between touching of the at least two touch positions is greater than a reference value;
as a result of the determination, when the elapsed time is greater than or equal to the reference value, performing a first sensing operation of detecting coordinates of real touch positions using the coordinates of touch position previously stored; and
as a result of the determination, when the elapsed time is smaller than the reference value, performing a second sensing operation of detecting coordinates of real touch positions using an impedance of the touch pattern which vary depending on the touch position.

13. The touch position detecting method as set forth in claim 12, wherein the determining whether or not the elapsed time is greater than the reference value includes:
calculating and storing a first coordinates corresponding to the first touch signal that indicates one of the first touch patterns is touched and a second coordinates corresponding to the second touch signal that indicates one of the second touch patterns is touched;
determining whether or not elapsed time between receipt of the first touch signal that indicates at least two of the first touch patterns are touched and the second touch signal that indicates at least two of the second touch patterns are touched and receipt of the first touch signal that indicates one of the first touch patterns is touched and the second touch signal that indicates one of the second touch patterns is touched is greater than the reference value; and
calculating and storing a third coordinates corresponding to the first touch signal that indicates at least two of the first touch patterns are touched and a fourth coordinates corresponding to the second touch signal that indicates at least two of the second touch patterns are touched.

14. The touch position detecting method as set forth in claim 13, when one of the third coordinates is the same as the first coordinates, the third coordinates are different from each other, one of the fourth coordinates is the same as the second coordinates, and the fourth coordinates are different from each other, the first sensing operation is performed.

15. The touch position detecting method as set forth in claim 12, when the first touch signals indicating that at least two of the first touch patterns are touched and the second touch signals indicating that at least two of the second touch patterns are touched are generated, the second sensing operation is performed by using impedances of the touch patterns which vary depending on the touch position with respect to at least one of the touched first and second touch patterns.

16. The touch position detecting method as set forth in claim 12, when the first touch signals indicating that at least two of the first touch patterns are touched and the second touch signals indicating that at least two of the second touch patterns are touched are generated, performing the second sensing operation includes:
applying a pulse signal to one of the touched second touch patterns; and
determining through which of the touched first touch patterns the pulse signal is output.

17. The touch position detecting method as set forth in claim 12, further comprising setting a discrimination region required to discriminate the real touch positions on the touch panel, wherein the determination, the first sensing operation, and the second sensing operation are performed when the touch positions have a plurality of coordinates within the discrimination region.

18. The touch position detecting method as set forth in claim 12, further comprising determining whether or not an application program executed in the input device needs to calculate the coordinates of the real touch positions, wherein as a result of the determination, when the application program needs to calculate the coordinates of the real touch positions, the determination, the first sensing operation, and the second sensing operation are performed.

19. The touch position detecting method as set forth in claim 12, further comprising determining whether or not a rotational axis of the coordinates of the touch positions is identical to the first or second direction, wherein as a result of the determination, when the rotational axis is identical to the first or second direction, the second sensing operation is performed.
